(19) United States
(12) Patent Application Publication
(10) Pub. No.: US 2006/0114479 A1
(43) Pub. Date: Jun. 1, 2006

(54) Accelerated image enhancement

(75) Inventor: George C. John, Austin, TX (US)

Correspondence Address: ANDERSON & JANSSON, L.L.P., 9501 N. CAPITAL OF TX HWY. #202, AUSTIN, TX, 78759, US

(73) Assignee: SozoTek, Inc.

(21) Appl. No.: 11/060,969

(22) Filed: Feb. 18, 2005

Related U.S. Application Data
(60) Provisional application No. 60/631,046, filed on Nov. 26, 2004.

(51) Int. Cl. G06K 15/02

(52) U.S. Cl. 358/1.2

(57) ABSTRACT

Provided is a computer system and method for processing images. The method includes operating on the one or more images at a first resolution size, the operating providing a low frequency component and a high frequency component of the one or more images, downsizing the low frequency component of the one or more images to at least a second resolution size, enhancing the downsized one or more images, upsizing the enhanced one or more images to the first resolution size, and combining the upsized and enhanced one or more images with the one or more image at the first resolution size with the high frequency component of the one or more images.

### CROSS-REFERENCE TO RELATED APPLICATIONS

This application claims priority to U.S. Provisional Ser. No. 60/631,046, filed Nov. 26, 2004, having the same inventor, and is incorporated herein by reference in its entirety.

### TECHNICAL FIELD

The present application relates generally to the field of processing image data, and more particularly, to accelerate image enhancement.

### SUMMARY

In one aspect, a method includes but is not limited to operating on the one or more images at a first resolution size, the operating providing a low frequency component and a high frequency component of the one or more images, downsizing the low frequency component of the one or more images to at least a second resolution size, enhancing the downsized one or more images, upsizing the enhanced one or more images to the first resolution size, and combining the upsized and enhanced one or more images with the one or more image at the first resolution size with the high frequency component of the one or more images.

In another aspect a method for receiving one or more enhanced images includes, but is not limited to receiving one or more images from an image storing and/or generating device and enhancing the one or more images, the enhancing including operating on the one or more images at a first resolution size, the operating providing a high frequency component of the one or more images and a low frequency component of the one or more images; downsizing the low pass component of the one or more images to at least a second resolution size; enhancing the downsized one or more images; upsizing the enhanced one or more images to the first resolution size; and adding the high pass component of the one or more images to the upsized and enhanced one or more images.

Another aspect is directed to a computer system including but not limited to a processor; a memory coupled to the processor; and an image processing module coupled to the memory, the image processing module configurable to operate on one or more images at a first resolution size, the operations to provide a low frequency component and a high frequency component of the one or more images, the image processing module configurable to downsize the low frequency component of the one or more images to at least a second resolution size, the image processing module configurable to enhance the downsized one or more images, the image processing module configurable to upsize the enhanced one or more images to the first resolution size, and the image processing module configurable to combine the upsized and enhanced one or more images with the one or more image at the first resolution size with the high frequency component of the one or more images.

Another aspect is directed to a mobile device including but not limited to a receiver configurable to connect with a server; a transmitter coupled to the receiver, the transmitter configured to transmit image data of the mobile device; a memory coupled to the receiver and the transmitter, the memory configured to receive and/or transmit the image data to the server, the server configured with an image processing module to operate on the image data, the image processing module including a low pass filter configurable to provide a low frequency component and a high frequency component of the image data at a second resolution size; an enhancement module configurable to enhance the image data; an interpolator configurable to upsize the enhanced image data to the first resolution size; and a combiner module configurable to combine the upsized and enhanced image data at the first resolution size with the high frequency component of the image data.

Another aspect is directed to a computer program product including but not limited to a computer readable medium configured to perform one or more acts for image processing, the one or more acts including but not limited to operating on the one or more images at a first resolution size, the operating providing a low frequency component and a high frequency component of the one or more images; downsizing the low frequency component of the one or more images to at least a second resolution size; enhancing the downsized one or more images; upsizing the enhanced one or more images to the first resolution size; and combining the upsized and enhanced one or more images with the one or more image at the first resolution size with the high frequency component of the one or more images.

In an embodiment, the combining the upsized and enhanced one or more images with the one or more image at the first resolution size with the high frequency component of the one or more images can include adding the high frequency component to the enhanced low frequency component, the adding resulting in an enhanced image at the first resolution size. The adding the high pass component of the one or more images to the upsized and enhanced one or more images can include amplifying the high frequency component, the amplifying enhancing detail of the one or more images. The enhancing the downsized one or more images can include one or more of suppressing noise of the image, enhancing fine details of the image, enhancing shadow details of the image, and/or enhancing color of the image. The operating on the one or more images at a first resolution size, the operating providing a low frequency component and a high frequency component of the one or more images can include but is not limited to applying a low pass filter to the one or more images at the first resolution size; down sizing the filtered one or more images to the second resolution size; up sizing the filtered one or more images at the second resolution size to the first resolution size; and subtracting the upsized filtered one or more images from the one or more images at the first resolution size, the subtracting providing the high frequency component of the one or more images.

In one embodiment, the operating on the one or more images at a first resolution size can include but is not limited to applying one or more of a Gaussian low pass filter, one or more wavelet transforms, and/or an edge protecting low pass filter. In one embodiment, the acts can further include repeating the operating on the one or more images at a first resolution size, the operating providing the low frequency component and a high frequency component of the one or more images, the repeating can include downsizing the low frequency component of the one or more images to at least a third resolution size; enhancing the downsized one or more images; upsizing the enhanced one or more images to the second resolution size; combining the enhanced one or more images at the second resolution size with a high frequency component at the second resolution size; upsizing the combined enhanced one or more images at the second resolution size to the first resolution size; and combining the upsized and enhanced one or more images at the first resolution size with the high frequency component of the one or more images.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject described herein will become apparent in the text set forth herein.

### BRIEF DESCRIPTION OF THE DRAWINGS

A better understanding of the subject matter of the present application can be obtained when the following detailed description of the disclosed embodiments is considered in conjunction with the following drawings, in which:

FIG. 1 is a block diagram of an exemplary computer architecture that supports the claimed subject matter;

FIG. 2 is a block diagram of a network environment appropriate for embodiments of the subject matter of the present application.

FIG. 3 is a flow diagram illustrating a method in accordance with an embodiment of the subject matter of the present application.

FIG. 4 is a block diagram illustrating a pyramid construction procedure with image enhancement in accordance with an embodiment of the subject matter of the present application.

FIG. 5 is a block diagram illustrating the pyramid construction in accordance with an embodiment of the subject matter of the present application.

FIG. 6 is a block diagram illustrating reconstruction of an image from a pyramid n accordance with an embodiment of the subject matter of the present application.

### DETAILED DESCRIPTION OF THE DRAWINGS

Those with skill in the computing arts will recognize that the disclosed embodiments have relevance to a wide variety of applications and architectures in addition to those described below. In addition, the functionality of the subject matter of the present application can be implemented in software, hardware, or a combination of software and hardware. The hardware portion can be implemented using specialized logic; the software portion can be stored in a memory or recording medium and executed by a suitable instruction execution system such as a microprocessor.

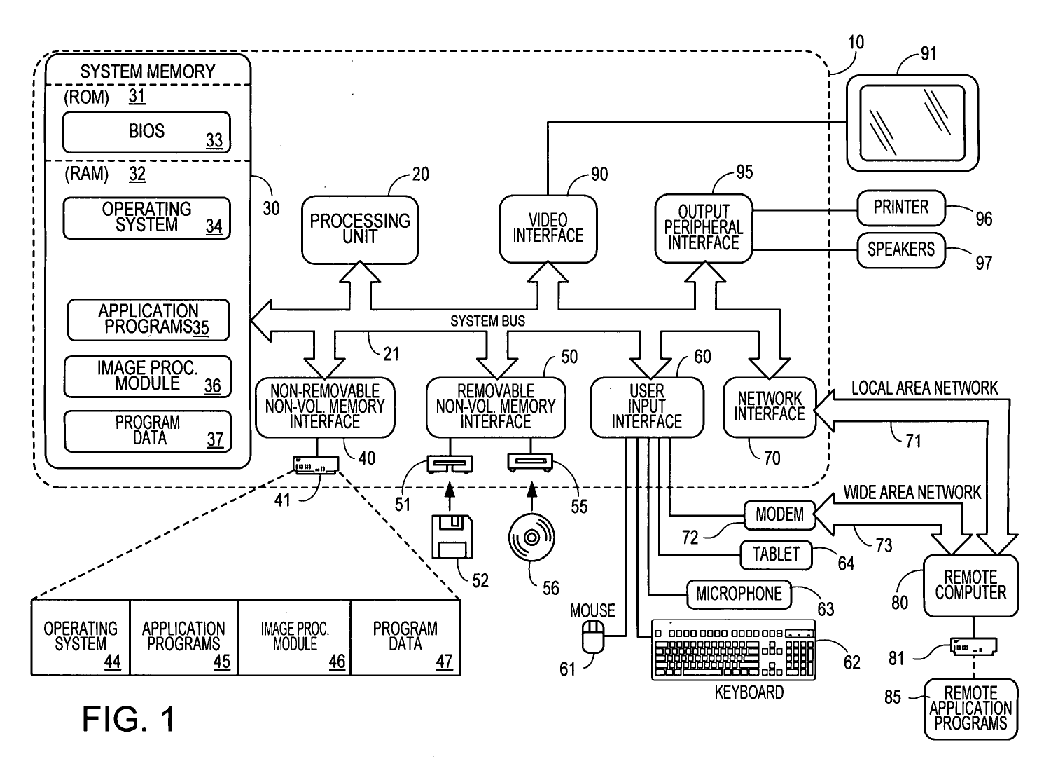

With reference to FIG. 1, an exemplary computing system for implementing the embodiments and includes a general purpose computing device in the form of a computer 10. Components of the computer 10 may include, but are not limited to, a processing unit 20, a system memory 30, and a system bus 21 that couples various system components including the system memory to the processing unit 20. The system bus 21 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 10 typically includes a variety of computer readable media. Computer readable media can be any available media that can be accessed by the computer 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 10. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 30 includes computer storage media in the form of volatile and/or nonvolatile memory such as read only memory (ROM) 31 and random access memory (RAM) 32. A basic input/output system 33 (BIOS), containing the basic routines that help to transfer information between elements within computer 10, such as during start-up, is typically stored in ROM 31. RAM 32 typically contains data and/or program modules that are immediately accessible to and/or presently being operated on by processing unit 20. By way of example, and not limitation, FIG. 1 illustrates operating system 34, application programs 35, other program modules 36 and program data 37. FIG. 1 is shown with program modules 36 including an image processing module in accordance with an embodiment as described herein.

The computer 10 may also include other removable/non-removable, volatile/nonvolatile computer storage media. By way of example only, FIG. 1 illustrates a hard disk drive 41 that reads from or writes to non-removable, nonvolatile magnetic media, a magnetic disk drive 51 that reads from or writes to a removable, nonvolatile magnetic disk 52, and an optical disk drive 55 that reads from or writes to a removable, nonvolatile optical disk 56 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 41 is typically connected to the system bus 21 through a non-removable memory interface such as interface 40, and magnetic disk drive 51 and optical disk drive 55 are typically connected to the system bus 21 by a removable memory interface, such as interface 50. An interface for purposes of this disclosure can mean a location on a device for inserting a drive such as hard disk drive 41 in a secured fashion, or a in a more unsecured fashion, such as interface 50. In either case, an interface includes a location for electronically attaching additional parts to the computer 10.

The drives and their associated computer storage media, discussed above and illustrated in FIG. 1, provide storage of computer readable instructions, data structures, program modules and other data for the computer 10. In FIG. 1, for example, hard disk drive 41 is illustrated as storing operating system 44, application programs 45, other program modules, including image processing module 46 and program data 47. Program modules 46 is shown including an image processing module, which can be configured as either located in modules 36 or 46, or both locations, as one with skill in the art will appreciate. More specifically, image processing modules 36 and 46 could be in non-volatile memory in some embodiments wherein such an image processing module runs automatically in an environment, such as in a cellular phone. In other embodiments, image processing modules could be part of a personal system on a hand-held device such as a personal digital assistant (PDA) and exist only in RAM-type memory. Note that these components can either be the same as or different from operating system 34, application programs 35, other program modules, including queuing module 36, and program data 37. Operating system 44, application programs 45, other program modules, including image processing module 46, and program data 47 are given different numbers hereto illustrate that, at a minimum, they are different copies. A user may enter commands and information into the computer 10 through input devices such as a tablet, or electronic digitizer, 64, a microphone 63, a keyboard 62 and pointing device 61, commonly referred to as a mouse, trackball or touch pad. Other input devices (not shown) may include a joystick, game pad, satellite dish, scanner, or the like. These and other input devices are often connected to the processing unit 20 through a user input interface 60 that is coupled to the system bus, but may be connected by other interface and bus structures, such as a parallel port, game port or a universal serial bus (USB). A monitor 91 or other type of display device is also connected to the system bus 21 via an interface, such as a video interface 90. The monitor 91 may also be integrated with a touch-screen panel or the like. Note that the monitor and/or touch screen panel can be physically coupled to a housing in which the computing device 10 is incorporated, such as in a tablet-type personal computer. In addition, computers such as the computing device 10 may also include other peripheral output devices such as speakers 97 and printer 96, which may be connected through an output peripheral interface 95 or the like.

The computer 10 may operate in a networked environment using logical connections to one or more remote computers, which could be other cell phones with a processor or other computers, such as a remote computer 80. The remote computer 80 may be a personal computer, a server, a router, a network PC, PDA, cell phone, a peer device or other common network node, and typically includes many or all of the elements described above relative to the computer 10, although only a memory storage device 81 has been illustrated in FIG. 1. The logical connections depicted in FIG. 1 include a local area network (LAN) 71 and a wide area network (WAN) 73, but may also include other networks. Such networking environments are commonplace in offices, enterprise-wide computer networks, intranets and the Internet. For example, in the subject matter of the present application, the computer system 10 may comprise the source machine from which data is being migrated, and the remote computer 80 may comprise the destination machine. Note however that source and destination machines need not be connected by a network or any other means, but instead, data may be migrated via any media capable of being written by the source platform and read by the destination platform or platforms.

When used in a LAN or WLAN networking environment, the computer 10 is connected to the LAN through a network interface or adapter 70. When used in a WAN networking environment, the computer 10 typically includes a modem 72 or other means for establishing communications over the WAN 73, such as the Internet. The modem 72, which may be internal or external, may be connected to the system bus 21 via the user input interface 60 or other appropriate mechanism. In a networked environment, program modules depicted relative to the computer 10, or portions thereof, may be stored in the remote memory storage device. By way of example, and not limitation, FIG. 1 illustrates remote application programs 85 as residing on memory device 81. It will be appreciated that the network connections shown are exemplary and other means of establishing a communications link between the computers may be used.

In the description that follows, the subject matter of the application will be described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operation described hereinafter can also be implemented in hardware.

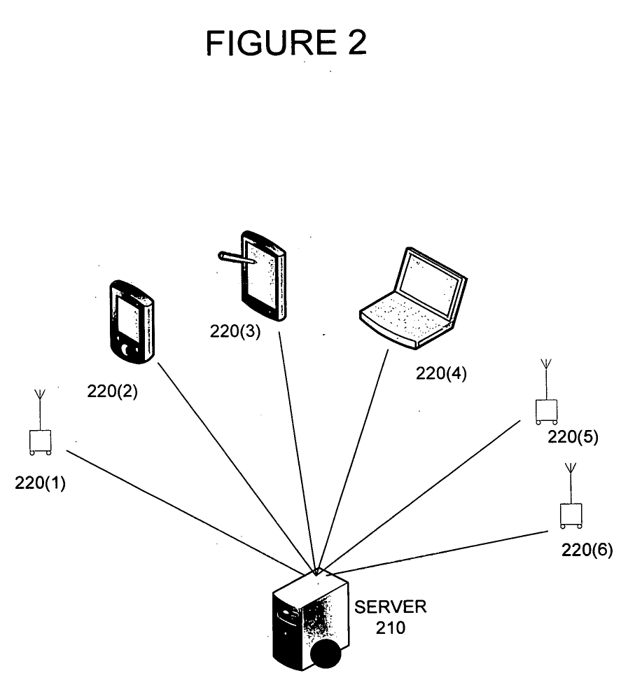

Referring to FIG. 2, a diagram of a network appropriate for embodiments herein is shown. The network includes a server 210. The term “server” as used herein refers to a computing device configurable to be a decision-making device in the context of an environment, which could be a network, having at least two computing devices, one of which being a controllable component. Components 220 as shown in FIG. 2 can be configurable to be controllable components. Alternatively, one or more of components 220 can be configurable to operate as a “server” if they are configurable to be decision-making devices capable of performing at least some of the acts as disclosed herein, as one of skill in the art with the benefit of the present application will appreciate. A “server” may be substantially any decision-making device for purposes of the present application capable of performing in a fashion similar to that described herein and outwardly appearing as a mobile or stationary device, such as a personal computer (PC), a pager, a personal digital assistant (PDA), a wired or wireless telephone, a mapping device, or the like. As one of skill in the art appreciates, the form of a computing device typically relates to the function of a computing device with respect to the size of the form required to hold components for computing as required by a system. Thus, many forms for holding a “server” are within the scope of that term as described herein.

Server 210 can be a printer with communication capabilities to connect with a plurality of components 220, which can be interact with server 210 via a wired or wireless connection 230. Connection 230 could include a wireless local area network connection (WLAN) or other method of wireless communication of data. WLANs operate by connecting mobile devices to a base station and using signal strength sensing to determine a location of a mobile device. Other wireless communication connections can include a satellite connection or the like as one of skill in the art with the benefit of the present disclosure will appreciate.

Components 220 can include receivers and transmitters to interact with server 210. Components 220 are shown including different types of components, including component 220(1) which could be a simple device capable of only receiving and displaying images or taking digital images and transmitting the images to server 210. Component 220(2) is shown as a personal electronic assistant, which could be configured to both send digital images and/or receive images as generated by server 210. Component 220(3) is shown as a tablet personal computer (PC) which can also be configured to both send and/or receive digital images. Component 220(4) is shown as a laptop or notebook computer which can also send and/or receive digital images. Components 220(5) could be implemented as a simple mobile device which could be configured to receive digital images. Component 220(6) could be implemented as a cellular telephone and include a digital camera in accordance with embodiments herein.

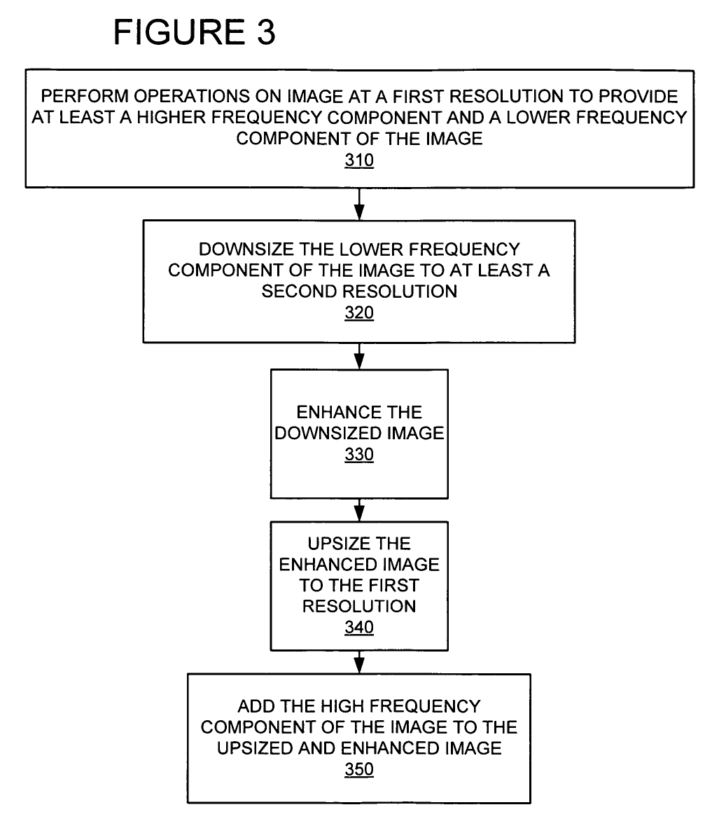

Referring now to FIG. 3, a flow diagram illustrates an embodiment for image processing. More specifically, FIG. 3 illustrates a flow diagram for image processing modules 36 and 46 shown in FIG. 1.

Image processing modules 36 and 46 can be configurable to enhance images collected by a digital camera. For purposes of the present application, enhancement can include but is not limited to noise suppression enhancement, fine detail enhancement, and shadow detail enhancement. Specifically, color enhancement can include but is not limited to adjustments to color, removal of color bias, and increasing color saturation. Color bias can include undesirable color casts in portions of the image. Shadow detail enhancement can include improving details in dark areas of an image.

Known techniques for enhancing digital images require significant amounts of processing time depending on the image size and required enhancements. An embodiment is directed to efficiently providing quality digital image enhancements. The enhancements can be performed via first connecting with an image storing and/or generating device, the image storing and/or generating device generating and/or storing one or more images. For example a cell phone or digital camera or PC can be such a device. The image storing and/or generating device can be configured to transmit one or more images to a server. In an embodiment, the device can be configurable to upload and/or download the one or more enhanced images. In an embodiment, a server can be configurable to enhance the one or more images and forward the enhanced images to one or more of another server or back to the device.

Referring now to FIG. 3, a flow diagram illustrates a method for enhancing images with reduced processing time according to an embodiment. Block 310 provides for performing one or more operations on one or more images at a first resolution size, the one or more operations providing at least a higher frequency resolution component of the one or more images and a lower frequency component of the one or more images. The operations performed for block 310 can include, but are not limited to, Gaussian-type filtering, such as low pass filtering to provide a low pass, low frequency component. Other filtering operations can include wavelet transform operations, edge protecting filters and the like that also produce a low frequency component. Other operations, such as subtracting the Gaussian-type filtered image from the original image results in a Laplacian image having a high pass component, consequently holding the high frequency components of the image. In one embodiment, the filtered image is first down sized and upsized prior to subtracting the Gaussian-type filtered image from the original image. The operations can include any operation that results in an exact or near-exact reconstruction of the original image. Those of skill in the art will appreciate that linear and non-linear operations, such as wavelet operations, can result in sufficient reconstruction of the image. The reconstruction capabilities of the operations depend on system requirements.

Block 320 provides for downsizing the lower frequency component of the one or more images to at least a second resolution size. Those of skill in the art will appreciate that a combined filtering and downsizing operation can be performed by performing a decimation operation.

Block 330 provides for enhancing the downsized one or more images. The enhancing can include, but is not limited to color enhancement, noise suppression enhancement, fine detail enhancement, and shadow detail enhancement. Fine detail enhancement can also be performed on higher resolution images using the higher frequency components of the image. The type of enhancement provided can, in one embodiment, be a function of the resolution size of the image. More particularly, if an enhancement can be performed at a first resolution size more efficiently than a second resolution size, an embodiment can operate on such images in accordance with predetermined parameters indicating a resolution size appropriate for a predetermined enhancement.

Block 340 provides for upsizing the enhanced one or more images to the first resolution size. The upsizing can include upsizing in accordance with exact reconstruction techniques.

Block 350 provides for adding the high frequency component of the one or more images to the upsized and enhanced one or more images. The upsized and enhanced image combined with the high frequency component provides a better-than-exact reconstruction of the original image.

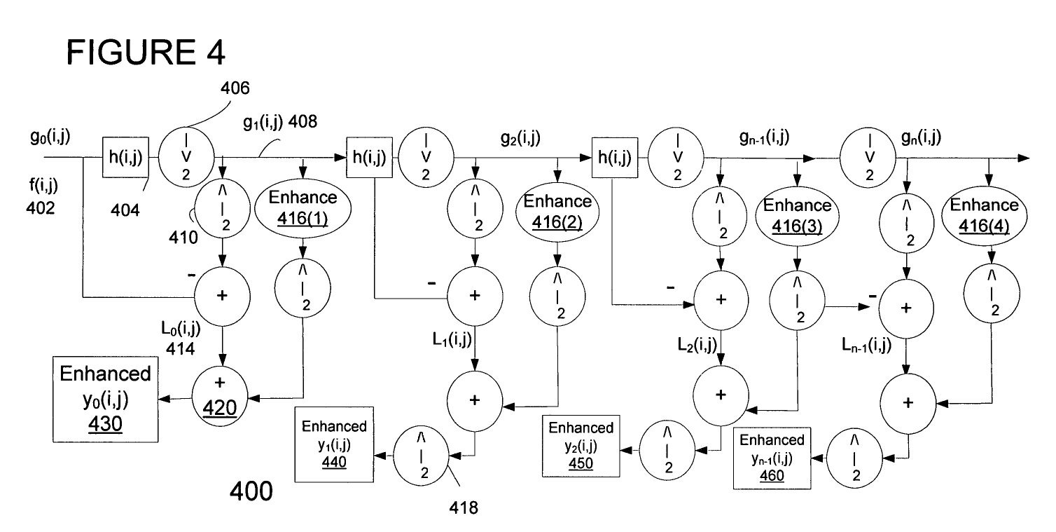

As described in the method shown in FIG. 3 can be accomplished by building a Laplacian pyramid. Referring now to FIG. 4, a signal representation 400 illustrates the construction of a Laplacian pyramid appropriate for embodiments herein. More particularly, FIG. 4 illustrates one method of producing a Laplacian pyramid by low pass filtering an original image with a Gaussian impulse response, downsizing, upsizing and subtracting the result from the original image. The high frequency details from the image can be found in the difference image. The resulting low pass filtered image can then be subsampled without loss of detail because the Laplacian high frequency details are saved.

As shown, an image f(i,j) 402 enters transfer function 404 wherein a Gaussian low pass filter is applied. The image 402 can be either an original image or an image that has been first filtered to remove noise before applying a low pass filter. For example, as one of skill in the art will appreciate, an image can have errors that can be altered by applying a rudimentary filter. For example, a simple median filter for reducing impulse noise may be used. Impulse noise may represent, for example, a spike in pixel values associated with a speck of dust in an image.

The resulting image is down sampled by two 406 and produces g₁(i,j), representing a Gaussian-filtered representation of the image. The down sampling can be performed by any appropriate interpolation method. For example, a common method of down sampling includes determining the mean between pixels. The image g₁(i,j) 408 is then up sampled by two 410 to match the resolution of the original image 402. The up sampling can be performed by an inverse of the down sampling method. As one of skill in the art will appreciate, the up sampling is generally the inverse method followed to accomplish the down sampling to prevent data loss. Next, the up sampled image is subtracted from the original image 412 to produce a first Laplacian image L₀(i,j) 414. As shown in FIG. 4, the process can be repeated by applying a low pass filter h(i,j) on the image g₁(i,j) 408 and repeating the down sampling and up sampling as described. The resulting combination of L₍₀₍ₙ₋₁₎₎(i,j) images is referred to as a Laplacian pyramid. As shown in FIG. 4, a Laplacian pyramid can be constructed by low pass filtering an original image with a Gaussian impulse response h(i,j) 404. The result from the low pass filtering is then subtracted 414 from the original image 402. The resulting difference image 414 contains the high-pass frequency detail of the image. The combination of the high-pass frequency component and the low pass components can reconstruct the original image as near lossless. Accordingly, a Laplacian pyramid can be formed according to the equation L_{i,j}=G_{i,j}−expanded(G_{i,j+1}), and the Gaussian pyramid can be formed according to the equation G_{,i,j}=L_{i,j}+expanded(G_{i,j+1}).

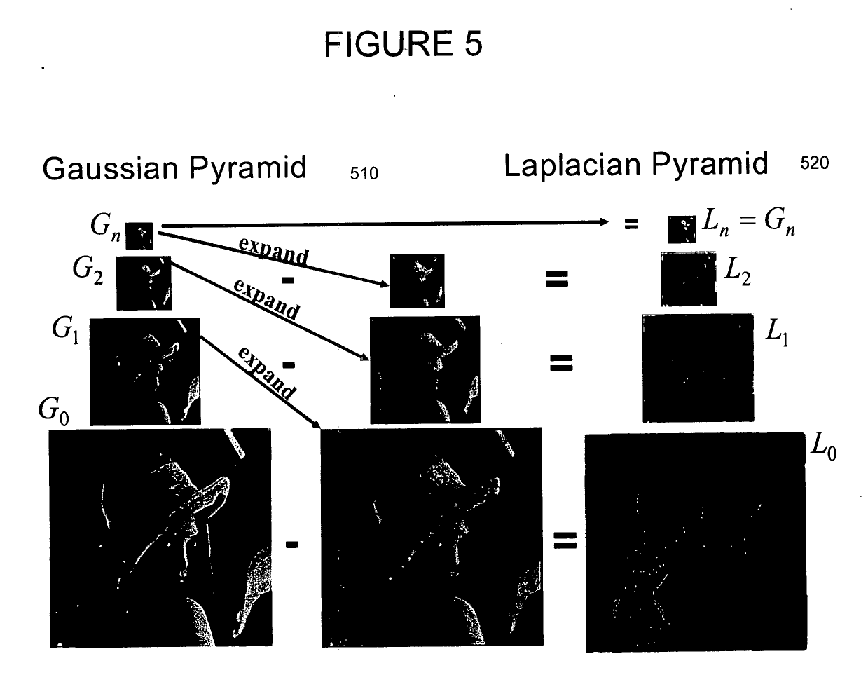

According to an embodiment, rather than reconstructing the original image, enhancement of the image is accomplished by performing operations on one or more of the Gaussian subsampled images gₙ(i,j) and/or performing operations on one or more of the Laplacian images Lₙ(i,j). According to an embodiment, the Laplacian high frequency component image is added to the low pass image, but with either or both of the low pass image being enhanced and/or the high frequency image enhanced. Referring back to FIG. 4, enhancements can be performed on the lower resolution images gₙ(i,j) as shown by enhancement blocks 416(1-4). The image is then up sampled (e.g. block 418) and added to the difference image as shown by summer 420. The resulting image is illustrated by blocks 430, 440, 450 and 460. The resulting images y(i,j) are up sampled to a next higher level of resolution to prepare for reconstruction. More particularly, if a lower resolution image is enhanced, the reconstruction of the enhanced reconstructed image requires adding the Laplacian image from the higher levels as described in the reconstruction method described with respect to FIG. 5, explained in more detail below. Further, if combined levels of enhancement are desired, after reconstruction of an image enhanced is performed, for example at a first level of resolution, the resulting image resized to the original image size can be used as the original image 402 and the process repeated for a next level of resolution enhancement.

The high frequency Laplace images, also referred to as “difference images” can be enhanced by multiplying the image by a factor greater than one prior to reconstructing the image. Multiplying the difference image by an amplification factor greater than one can enhance the details of an image. In one embodiment, the difference image can be multiplied an integer value. As will be appreciated by those of skill in the art, the fine detail enhancement performed on the difference images can be performed at any level of resolution. In one embodiment, the higher resolution difference images are enhanced after applying other enhancements to lower resolution images.

Referring now to FIG. 5, the signal representation shown in FIG. 4 is shown using images. More particularly, FIG. 5 shows how the Gaussian pyramid 510 and the Laplacian pyramid 520 operate together to enable reconstruction of an image by breaking down an image into high frequency and low frequency components. As shown, the Gaussian low pass components are shown by G₀, G₁, G₂ and Gₙ corresponding with the signals g(i,j) in FIG. 4. Likewise high frequency components are shown by L₀, L₁, L₂ and Lₙ corresponding with the signals L(i,j) in FIG. 4. In an embodiment, enhancements are performed on the images shown by G₁, G₂ and Gₙ representing lower resolution images of the original with high frequency data removed.

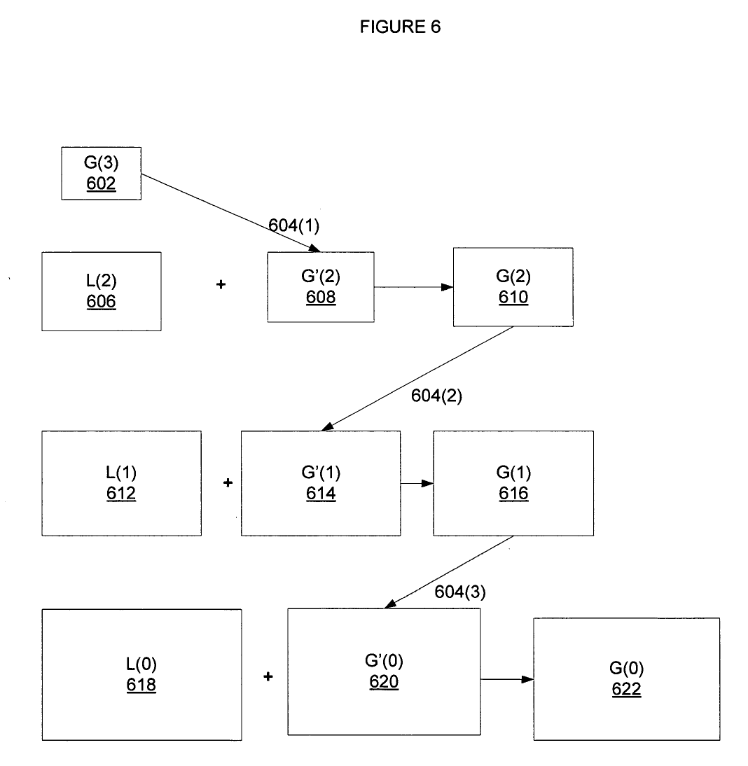

Referring now to FIG. 6, an embodiment is directed to reconstructing an original image with enhancements performed at one or more levels of an image pyramid. FIG. 6 illustrates a Laplacian pyramid according to an embodiment with three levels of filtering. At one or more levels of filtering, image processing can occur to enhance the image. More particularly, FIG. 6 illustrates a level 3 G(3) image 602 representing a Gaussian low pass filtered image constructing according to the method described above with reference to FIG. 4. According to an embodiment, the image 602 can be enhanced to correct or alter the image as determined by system requirements, predetermined conditions of the image or the like. Image 602 is expanded 604 to upsize the image in accordance with the method used to down sample the image.

The Laplacian image L(2) 606 representing the high frequency components of the image at a second level of filtering can be added to the upsized image 608, G′(2), and the resulting image is an enhanced version of the image at level 2 shown by G(2) 610. The image represented by G(2) 610 can be further enhanced for those enhancements that are better performed at a second level of filtering or do not require a lower resolution level to enhance the efficiency of enhancing the image.

After an expansion 604(2) is performed on image G(2) 610, the Laplacian image L(1) 612 is added to the expanded and/or expanded and enhanced image G′(1) 614 resulting in a level one Gaussian image G(1) 616. Again, image enhancements can be performed on level one Gaussian image G(1) 616 according to the needs of the image, the efficiency of the enhancements as a function of the level of filtering and the like. Gaussian image G(1) 616 is then expanded 604(3). The top level of Laplacian image L(0) 618 is then added to the expanded Gaussian image as shown by top level Gaussian image G′(0) 620 to produce output G(0) 622.

According to an embodiment, images at each level of filtering, 0 to n, can be enhanced depending on the type of enhancement to be applied or the qualities of the image. Enhancements can be performed on one or more Gaussian images G(n) and/or on one or more Laplacian images L(n) according the type of enhancement required or desired. In one embodiment, a lower level of Gaussian image, such as G(3), is enhanced for color correction to lower processing time for color correction. More particularly, according to an embodiment, the level of filtering at which enhancement is performed is determined as a function of the processing time required for performing the enhancements. For example, in some systems, such as cell phone environments and the like, the enhancements allowable for images is limited by the processing time permitted in a system. In other systems, enhancements to be performed in near real time are severely limited by the processing time allowed by the system. For example, near real time systems wherein the image enhancements must be performed as seamlessly as possible have limited processing time to allow for image enhancements. In such systems, the level of filtering at which enhancements are performed according to an embodiment, is a function of processing time.

In another embodiment, the image to be enhanced could enter a system for enhancement with details concerning the image to be enhanced known ahead of time. For example, if a cell phone system is configured to allow for sending photos, the size of the image to be enhanced will be known ahead of time. Further, the type and abilities and common problems of a given digital camera may be known ahead of time. The information regarding the type of enhancements appropriate for different types of digital cameras can be stored and available via a table or the like for image processing modules 36 and 46. According to an embodiment, therefore, the level of filtering required for enhancement can be predetermined. Thus, according to an embodiment, the corrections can be made to enhance, for example, shadow details and color at a lower resolution that is determined according to predetermined parameters if they are available. If the processing time is limited, a process can be used to determine the best level of resolution for the processing time to accomplish an enhancement. If less processing time is available, a lower resolution version of the image, such as G(3) can be used for the enhancements.

The lower the resolution of the image to be processed, the greater the speed of enhancement processing. Thus, modules 36 and 46 can be further refined to construct a pyramid with additional levels and apply the techniques given above to, for example, to four or more levels of a pyramid. For larger images, for example, images of 2048×1600 pixels, the increase in processing speed is increased for pyramids with at least three or four levels.

In one embodiment, the level at which enhancements are performed takes into account the type of enhancements to be performed and the speed of processing. For example, for black level correction, depending on the size of the image, a first or second level resolution image enhancement.

According to an embodiment, the enhancements performed on lower resolution images enhance shadow details and color. Additionally, an embodiment is directed to improving the signal to noise ratios in digital images by performing enhancements at lower resolution levels of an image and reconstructing the image using a Laplacian pyramid technique. The signal to noise ratio for both color noise and impulse response noise is increased using the methods described with reference to FIGS. 3-6.

More particularly, luminance noise and chrominance noise in a digital image can be located in the high frequency components of an image, such as those shown in L(0)-L(n) in difference images shown in FIG. 5. Because enhancements are applied to the smaller image and do not affect the high frequency details kept in the difference images, the luminance noise and chrominance noise levels are not affected. Because the shadow details and color are enhanced but the luminance noise and chrominance noise remain the same in the final image, the overall ratio of signal to noise is improved.

In an alternate embodiment, the Laplacian and Gaussian pyramid methods described above can be performed by other methods. For example, a modfication to a wavelet transform can be used as described by Claypoole, Davis, Sweldens and Baraniuk in “Nonlinear Wavelet Transforms for Image Coding”, “Nonlinear Wavelet Transforms for Image Coding”, Asilomar Conference on Signals, Systems, and Computers, 1997, which reference is incorporated by reference in its entirety for all purposes. Specifically, a nonlinear transform is used with wavelet compression wherein a switch between different polynomial predictors is made based on local properties of an images, the switch causes a non-linear data dependent operator. Predictors used can take into account discontinuities in images along curves to preserve edge sharpness. The wavelet transform is used by first updating and then predicting. The update is performed on even samples based on odd samples yielding low pass coefficients. The low pass coefficients are used to predict the odd samples and provides the high pass coefficients. A linear update filter is used and the choice of predictor can depend on the data. The transform is only iterated on the low pass coefficients. Therefore, all low pass coefficients throughout the pyramid linearly depend on the data and are not affected by the non-linear predictor. The prediction can be based on low pass coefficients which are computed as in a classical wavelet transform. The transform can be performed backwards from coarse to fine scales and allow an encoder and decoder to be synchronized for reconstruction of an image similar to the Laplacian pyramid method disclosed herein.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified steps performed in the same or a different order.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The herein described aspects depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

We claim:

1. A method for processing one or more images comprising:
operating on the one or more images at a first resolution size, the operating providing a low frequency component and a high frequency component of the one or more images;
downsizing the low frequency component of the one or more images to at least a second resolution size;
enhancing the downsized one or more images;
upsizing the enhanced one or more images to the first resolution size; and
combining the upsized and enhanced one or more images with the one or more image at the first resolution size with the high frequency component of the one or more images.

2. The method of claim 1 wherein the combining the upsized and enhanced one or more images with the one or more image at the first resolution size with the high frequency component of the one or more images includes:
adding the high frequency component to the enhanced low frequency component, the adding resulting in an enhanced image at the first resolution size.

3. The method of claim 1 wherein the adding the high pass component of the one or more images to the upsized and enhanced one or more images includes:
amplifying the high frequency component, the amplifying enhancing detail of the one or more images.

4. The method of claim 3 wherein the amplifying is performed by multiplying the high frequency component by a number greater than one prior to the combining the upsized and enhanced one or more images with the high frequency component.

5. The method of claim 1 wherein the enhancing the downsized one or more images includes one or more of:
suppressing noise of the image;
enhancing fine details of the image;
enhancing shadow details of the image; and
enhancing color of the image.

6. The method of claim 1 wherein the operating on the one or more images at a first resolution size, the operating providing a low frequency component and a high frequency component of the one or more images includes:
applying a low pass filter to the one or more images at the first resolution size;
down sizing the filtered one or more images to the second resolution size;
up sizing the filtered one or more images at the second resolution size to the first resolution size; and
subtracting the upsized filtered one or more images from the one or more images at the first resolution size, the subtracting providing the high frequency component of the one or more images.

7. The method of claim 1 wherein the operating on the one or more images at a first resolution size, the operating providing a low frequency component and a high frequency component of the one or more images includes:
applying one or more of a Gaussian low pass filter, one or more wavelet transforms, and/or an edge protecting low pass filter;

8. The method of claim 6 wherein the applying a low pass filter and the down sizing the filtered one or more images to the second resolution size includes:
performing a single decimation operation including the applying the low pass filter and the down sizing.

9. The method of claim 1 further comprising:
repeating the operating on the one or more images at a first resolution size, the operating providing the low frequency component and a high frequency component of the one or more images, the repeating including:
downsizing the low frequency component of the one or more images to at least a third resolution size;
enhancing the downsized one or more images;
upsizing the enhanced one or more images to the second resolution size;
combining the enhanced one or more images at the second resolution size with a high frequency component at the second resolution size;
upsizing the combined enhanced one or more images at the second resolution size to the first resolution size; and
combining the upsized and enhanced one or more images at the first resolution size with the high frequency component of the one or more images.

10. A method for a receiving one or more enhanced images, the method comprising:
receiving one or more images from an image storing and/or generating device; and
enhancing the one or more images, the enhancing including:
operating on the one or more images at a first resolution size, the operating providing a high frequency component of the one or more images and a low frequency component of the one or more images;
downsizing the low pass component of the one or more images to at least a second resolution size;
enhancing the downsized one or more images;
upsizing the enhanced one or more images to the first resolution size; and
adding the high pass component of the one or more images to the upsized and enhanced one or more images.

11. The method of claim 10 further comprising:
connecting with the image storing and/or generating device, the image storing and/or generating device generating and/or storing one or more images, the device transmitting the one or more images to a server.

12. The method of claim 10 further comprising:
loading the enhanced one or more images on a second server.

13. A computer system comprising:
a processor;
a memory coupled to the processor;
an image processing module coupled to the memory, the image processing module configurable to operate on one or more images at a first resolution size, the operations to provide a low frequency component and a high frequency component of the one or more images, the image processing module configurable to downsize the low frequency component of the one or more images to at least a second resolution size, the image processing module configurable to enhance the downsized one or more images, the image processing module configurable to upsize the enhanced one or more images to the first resolution size, and the image processing module configurable to combine the upsized and enhanced one or more images with the one or more image at the first resolution size with the high frequency component of the one or more images.

14. A mobile device comprising:
a receiver configurable to connect with a server;
a transmitter coupled to the receiver, the transmitter configured to transmit image data of the mobile device;
a memory coupled to the receiver and the transmitter, the memory configured to receive and/or transmit the image data to the server, the server configured with an image processing module to operate on the image data, the image processing module including:
a low pass filter configurable to provide a low frequency component and a high frequency component of the image data at a second resolution size
an enhancement module configurable to enhance the image data;
an interpolator configurable to upsize the enhanced image data to the first resolution size; and
a combiner module configurable to combine the upsized and enhanced image data at the first resolution size with the high frequency component of the image data.

15. A computer program product comprising a computer readable medium configured to perform one or more acts for image processing, the one or more acts comprising:
operating on the one or more images at a first resolution size, the operating providing a low frequency component and a high frequency component of the one or more images;
downsizing the low frequency component of the one or more images to at least a second resolution size;
enhancing the downsized one or more images;
upsizing the enhanced one or more images to the first resolution size; and
combining the upsized and enhanced one or more images with the one or more image at the first resolution size with the high frequency component of the one or more images.

16. The computer program product of claim 15 wherein the combining the upsized and enhanced one or more images with the one or more image at the first resolution size with the high frequency component of the one or more images includes:
adding the high frequency component to the enhanced low frequency component, the adding resulting in an enhanced image at the first resolution size.

17. The computer program product of claim 15 wherein the adding the high pass component of the one or more images to the upsized and enhanced one or more images includes:
amplifying the high frequency component, the amplifying enhancing detail of the one or more images.

18. The computer program product of claim 15 wherein the enhancing the downsized one or more images includes one or more of:
suppressing noise of the image;
enhancing fine details of the image;
enhancing shadow details of the image; and
enhancing color of the image.

19. The computer program product of claim 15 wherein the operating on the one or more images at a first resolution size, the operating providing a low frequency component and a high frequency component of the one or more images includes:
applying a low pass filter to the one or more images at the first resolution size;
down sizing the filtered one or more images to the second resolution size;
up sizing the filtered one or more images at the second resolution size to the first resolution size; and
subtracting the upsized filtered one or more images from the one or more images at the first resolution size, the subtracting providing the high frequency component of the one or more images.

20. The computer program product of claim 15 wherein the operating on the one or more images at a first resolution size, the operating providing a low frequency component and a high frequency component of the one or more images includes:
applying one or more of a Gaussian low pass filter, one or more wavelet transforms, and/or an edge protecting low pass filter;

21. The computer program product of claim 15 further comprising:
repeating the operating on the one or more images at a first resolution size, the operating providing the low frequency component and a high frequency component of the one or more images, the repeating including:
downsizing the low frequency component of the one or more images to at least a third resolution size;
enhancing the downsized one or more images;
upsizing the enhanced one or more images to the second resolution size;
combining the enhanced one or more images at the second resolution size with a high frequency component at the second resolution size;
upsizing the combined enhanced one or more images at the second resolution size to the first resolution size; and
combining the upsized and enhanced one or more images at the first resolution size with the high frequency component of the one or more images.
